(19) United States
(12) Patent Application Publication
(10) Pub. No.: US 2024/0419477 A1
(43) Pub. Date: Dec. 19, 2024

(54) INFLUENCE COST CALCULATION APPARATUS, INFLUENCE COST CALCULATION METHOD, AND PROGRAM

(71) Applicant: NIPPON TELEGRAPH AND TELEPHONE CORPORATION, Tokyo (JP)

(72) Inventors: Ryo SATO, Tokyo (JP); Tomonari FUJIMOTO, Tokyo (JP); Motomu NAKAJIMA, Tokyo (JP)

(21) Appl. No.: 18/706,987

(22) PCT Filed: Dec. 21, 2021
(86) PCT No.: PCT/JP2021/047368

§ 371 Date: May 2, 2024

(51) Int. Cl. G06F 9/455; G06F 1/28

(52) U.S. Cl. CPC G06F 9/45558; G06F 1/28; G06F 2009/4557

(57) ABSTRACT

An impact cost calculation apparatus for calculating an impact cost in a case in which a virtual machine is migrated within a base or between the bases at a plurality of bases including the virtual machines includes a state confirmation unit configured to acquire either a login state or a process state, or both the login state and the process state, in each virtual machine provided at the base; and a degree-of-impact determination unit configured to calculate, for each virtual machine, an impact cost for a user caused by migration of the virtual machine, on the basis of either the login state or the process state or both the login state and the process state.

### TECHNICAL FIELD

The present invention relates to a technology for estimating the impact in a case in which a virtual machine is migrated between bases.

### BACKGROUND ART

In recent years, various network services or applications have been provided by a virtual machine (hereinafter referred to as a VM) operating on a server (a physical machines) at a plurality of bases (for example, data centers).

Further, in order to reduce the power purchase cost and decarbonize, or the like, each base may often receive power from two systems such as renewable energy generation such as solar power generation, and commercial power supplied by a power company.

In the renewable energy power generation, an amount of power supply fluctuates from moment to moment. Therefore, for example, when an amount of supply of renewable energy at base A has decreased, the VM of base A is migrated to base B which has a sufficient amount of supply of renewable energy, so that the renewable energy of base B can be used without waste and an amount of power purchased from a power company at base A can be reduced.

A live migration technology (Non-Patent Literature 1) and a planned failover technology (Non-Patent Literature 2), for example, are known as VM migration methods.

### CITATION LIST

### Non-Patent Literature

### Non-Patent Literature 1:

https://docs.microsoft.com/ja-jp/windows-server/virtualization/hyper-v/manage/live-migration-overview

### Non-Patent Literature 2:

https://social.technet.microsoft.com/Forums/windowsse rver/ja-JP/e5143d67-41a9-4996-827a-f62cc51e4dfb/hyperv

### SUMMARY OF INVENTION

### Technical Problem

Renewable energy can be effectively utilized by migration of VMs as described above, but there is a possibility that the migration of VMs may adversely impact the users who use the VMs.

Therefore, it is desirable to calculate a degree of impact caused by VM migration in advance, and perform the VM migration in consideration of the degree of impact. However, in the related art, there is no technology for calculating the degree of impact caused by VM migration.

The present invention has been made in view of the above point, and an object of the present invention is to provide a technology for calculating a degree of impact caused when moving VMs.

### Solution to Problem

According to the disclosed technology, there is provided an impact cost calculation apparatus for calculating an impact cost in a case in which a virtual machine is migrated within a base or between the bases at a plurality of bases including the virtual machines, the impact cost calculation apparatus including:
a state confirmation unit configured to acquire either a login state or a process state, or both the login state and the process state, in each virtual machine provided at the base; and
a degree-of-impact determination unit configured to calculate, for each virtual machine, an impact cost for a user caused by migration of the virtual machine, on the basis of either the login state or the process state or both the login state and the process state.

### Advantageous Effects of Invention

According to the disclosed technology, a technology for calculating a degree of impact caused when migrating the VMs is provided.

### BRIEF DESCRIPTION OF DRAWINGS

FIG. 1 is an overall configuration diagram of a system according to an embodiment of the present invention.

FIG. 2 is a diagram illustrating an example of VM migration.

FIG. 3 is a diagram illustrating live migration.

FIG. 4 is a diagram illustrating planned failover.

FIG. 5 is a diagram illustrating an overview of an embodiment.

FIG. 6 is a configuration diagram of a VM migration impact cost calculation apparatus.

FIG. 7 is a flowchart illustrating an operation of Example 1.

FIG. 8 is a flowchart illustrating an operation of Example 2.

FIG. 9 is a flowchart illustrating an operation of Example 3.

FIG. 10 is a diagram illustrating an example of use of impact cost.

FIG. 11 is a diagram illustrating a hardware configuration example of an apparatus.

### DESCRIPTION OF EMBODIMENTS

Hereinafter, an embodiment of the present invention (the present embodiment) will be described with reference to the drawings. The embodiment to be described hereinafter is merely an example, and an embodiment to which the present invention is applied is not limited to the following embodiment.

### (System Configuration and Operation Overview)

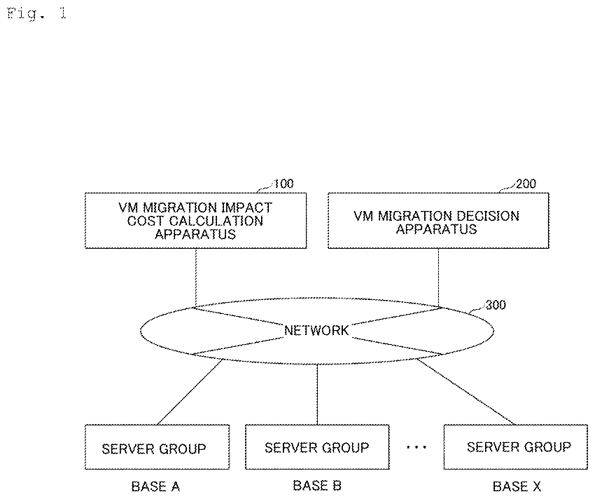

FIG. 1 illustrates an example of an overall configuration of a system according to the present embodiment. As illustrated in FIG. 1, a plurality of bases with server groups are connected to a network 300.

Further, a VM migration impact cost calculation apparatus 100 and a VM migration destination decision apparatus 200 are connected to a network 300. Further, one or a plurality of users are connected to each VM at each base. Here, the “user” may be a user terminal, or may be a NW apparatus that connects a network of the user to the VM.

At each base, commercial power provided by a power company is supplied, and power generated by renewable energy is supplied. There may be a base at which only commercial power supplied from a power company is supplied or a base at which only power generated by renewable energy is supplied.

Each server in each base has zero or more virtual machines (VMs). The virtual machine (VM) is a computer in which the same functions as a physical computer are realized with software. Each VM can be migrated between bases (or between servers within bases) according to a setting command from the VM migration destination decision apparatus 200, for example.

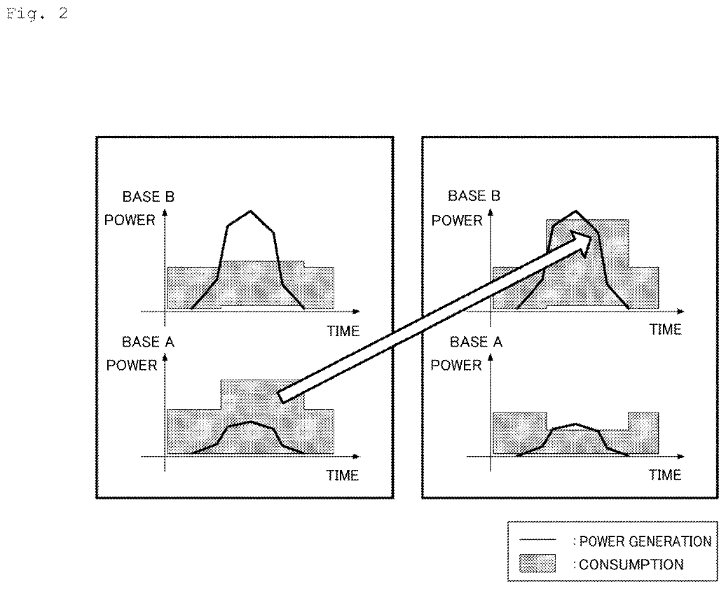

Therefore, as illustrated in FIG. 2, when an amount of supply of renewable energy at base A has decreased, the VM of base A is migrated to base B which has a sufficient amount of supply of renewable energy, so that the renewable energy of base B can be used without waste and an amount of power purchased from a power company at base A can be reduced.

However, since the migration of the VM is likely to impact a service depending on a use situation of the VM, it is necessary to migrate the VM in consideration of both the impact on the service and the reduction of an amount of power purchase.

Therefore, in the present embodiment, the VM migration impact cost calculation apparatus 100 determines the degree of impact due to the migration for each VM, and the VM migration destination decision apparatus 200 causes migration from the VMs with less impact. This makes it possible to reduce the amount of power purchased while minimizing the impact of fluctuation in an amount of supply of renewable energy. A function of the VM migration destination decision apparatus 200 may be included in the VM migration impact cost calculation apparatus 100.

### (VM Migration Method and Problem)

Live migration (LM) and planned failover are known as existing methods for moving VMs within a base or between bases.

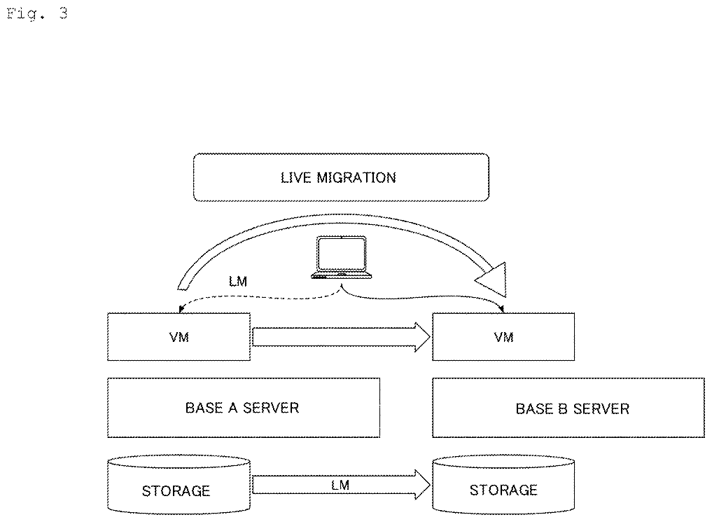

FIG. 3 illustrates an overview of live migration of a VM from a server in base A to a server in base B. In the live migration, since the VM can be migrated without stopping of applications in operation, there is no service interruption and no user impact. However, since the VM is inherited including a memory state, it takes a long time to migrate one VM when there is a large change in the memory state. Therefore, it is difficult to move a large number of VMs in a short period of time.

For the effective use of renewable energy, it is necessary to meet the demand for migration of a large number of VMs in a short period of time, but since it is difficult to migrate a large number of VMs in a short period of time with live migration, there is a possibility that required power consumption cannot be migrated at a required timing.

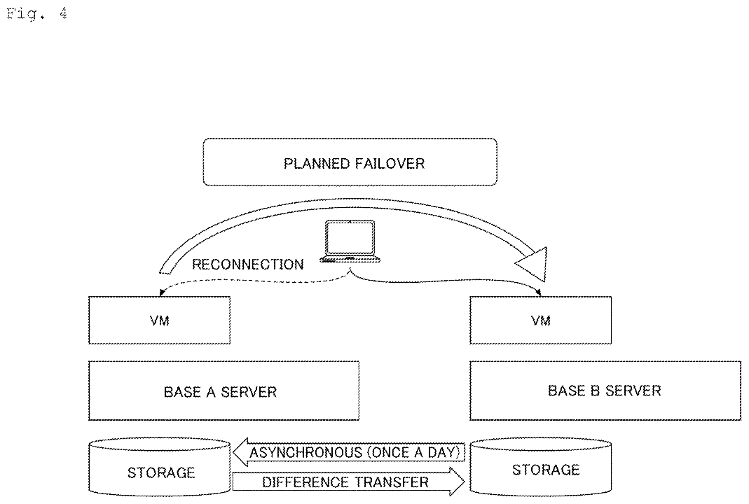

FIG. 4 illustrates an overview of a planned failover of a VM from a server in base A to a server in base B. The planned failover can migrate a large number of VMs because of simple reconnection. There is no data loss due to VM migration, but it is necessary to shut down a terminal connected to the VM and reconnect to the VM after the migration, which causes VM unavailable time and impacts on users.

As described above, when the VM is migrated using live migration, a time taken for migration increases depending on a distance between bases and a memory access situation, making it difficult to instantly migrate a large number of VMs from one base to another base. When the planned failover is performed, a large number of VMs can migrate, but user impact occurs.

### Overview of Embodiment

In the present embodiment, the VM migration impact cost calculation apparatus 100 calculates the degree of impact in a case in which a VM is migrated from one base to another base in the form of an impact cost for each VM.

The VM migration impact cost calculation apparatus 100 calculates the impact costs on the basis of, for example, a distance between a migration source and a migration destination, a distance to the user, a size of a communication bandwidth, a use situation of each VM, a strength of the coupling between the VMs, and the like.

The VM migration impact cost calculation apparatus 100 performs degree-of-impact evaluation at the time of VM migration at any time, and the VM migration destination decision apparatus 200 can decide a VM that is a migration target, a VM migration scheme, and the like on the basis of a result of the evaluation.

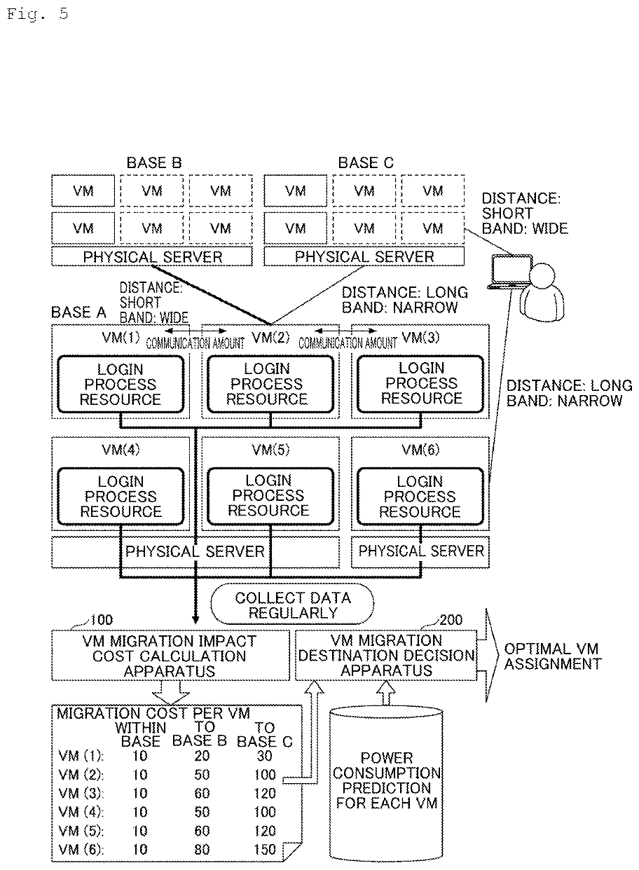

An overview of processing executed by the VM migration impact cost calculation apparatus 100 will be described with reference to FIG. 5. FIG. 5 illustrates an example in which the VM migration impact cost calculation apparatus 100 calculates a cost in a case in which a VM at base A is migrated. The VM migration impact cost calculation apparatus 100 can perform the same processing on each base.

As illustrated in FIG. 5, it is assumed that a process confirmation application that acquires a login state, a process state, a resource state, and the like is operating on each VM in base A. The VM migration impact cost calculation apparatus 100 periodically collects information (the login state, the process state, the resource state, the distance, the band, and the like) on each VM at base A, and calculates the cost in a case in which the VM is migrated to another server within the base, base B, or base C.

The VM migration destination decision apparatus 200 decides the VM migration destination on the basis of the cost of the degree of impact obtained by the VM migration impact cost calculation apparatus 100.

### (Apparatus Configuration)

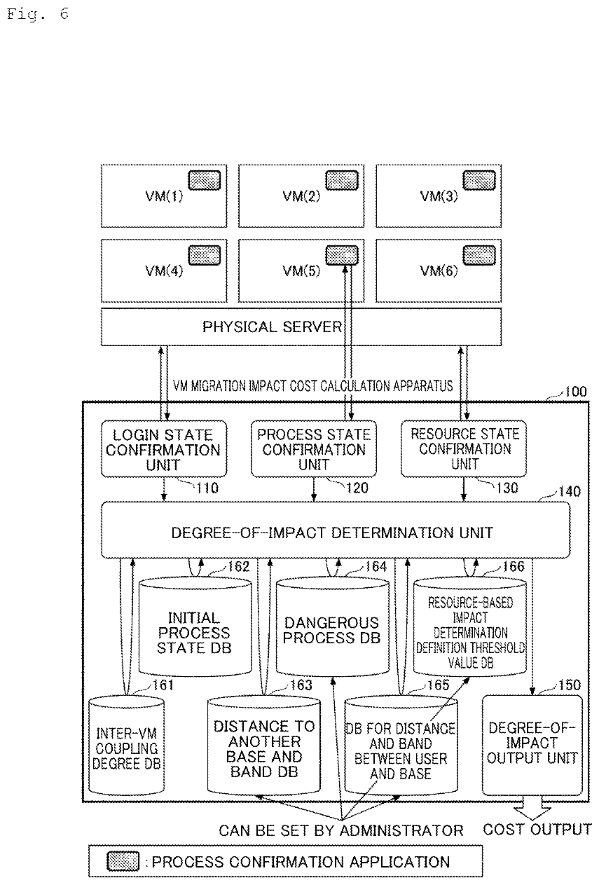

FIG. 6 is a diagram illustrating a configuration example of the VM migration impact cost calculation apparatus 100. As illustrated in FIG. 6, the VM migration impact cost calculation apparatus 100 includes a login state confirmation unit 110, a process state confirmation unit 120, a resource state confirmation unit 130, a degree-of-impact determination unit 140, and a degree-of-impact output unit 150. The “login state confirmation unit 110, the process state confirmation unit 120, and the resource state confirmation unit 130” may be collectively referred to as a “confirmation unit”. Further, the VM migration impact cost calculation apparatus 100 may be called an “impact cost calculation apparatus”.

Further, the VM migration impact cost calculation apparatus 100 includes an inter-VM coupling degree DB (database) 161, an initial process state DB 162, a distance-to-another-base and band DB 163, a dangerous process DB 164, a DB for a distance and a band between a user and a base 165, and a resource-based impact determination definition threshold value DB 166. Use examples of each DB will be described appropriately in Examples 1 to 3. A function overview of each unit is as follows.

The login state confirmation unit 110 acquires information as to whether or not a user accesses (logs in) each VM. The process state confirmation unit 120 acquires processes operating on each VM.

The resource state confirmation unit 130 acquires information on resources such as a memory use rate and a memory IO of each VM. The resources to be acquired are not limited to the memory use rate and the like, and it is also possible to acquire a CPU use rate and the like.

The degree-of-impact determination unit 140 receives data from any one, any plurality, or all of the login state confirmation unit 110, the process state confirmation unit 120, and the resource state confirmation unit 130, and calculates the impact cost when the VM has been migrated. The degree-of-impact output unit 150 outputs the impact cost for each VM and each migration destination calculated by the degree-of-impact determination unit 140. The output impact cost may be displayed on a display, or may be input to the VM migration destination decision apparatus 200.

Hereinafter, Examples 1 to 3 will be described as specific examples of calculation of the impact cost in the degree-of-impact determination unit 140. Further, an example of use of the calculated impact cost will be described after Examples 1 to 3. An example of calculation of the impact cost on the assumption that the VM at base A is migrated within the base or to another base, as illustrated in FIG. 5, will be described in Examples 1 to 3 to be described below.

Hereinafter, an example in which the impact cost based on the inter-VM coupling degree in Example 2 is added to the impact cost in Example 1, and an impact cost related to the operation impact in Example 3 is also added is illustrated, but this is an example. It is also possible to use each of the impact costs of Examples 1, 2, and 3 alone. Moreover, it is also possible to use each of the plurality of impact costs (addition amount) described in Example 1 independently.

### Example 1

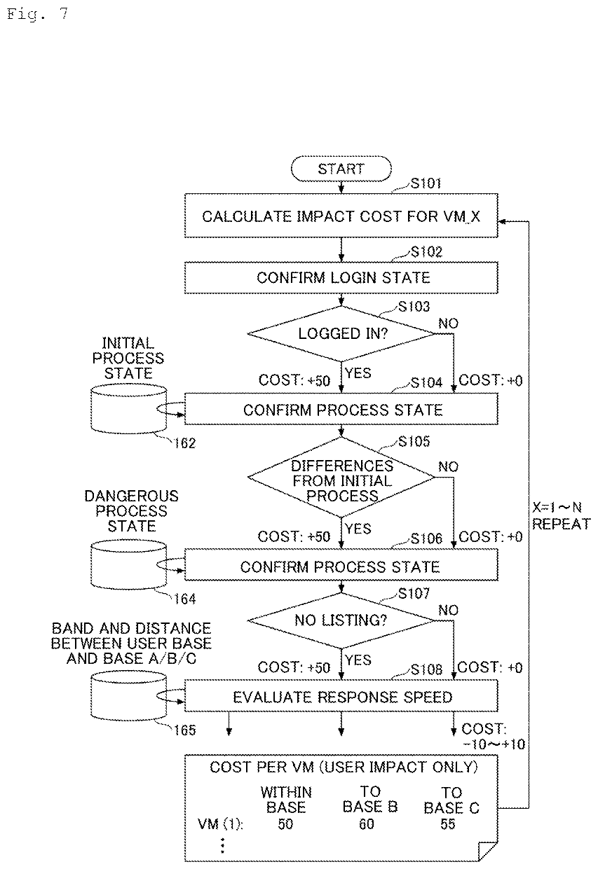

In Example 1, an example of impact cost calculation considering the impact on the user from the login state, process state, a distance and a band between the user and each base will be described. Description will be made according to a procedure of a flowchart in FIG. 7.

### <S101: Step 1>

The degree-of-impact determination unit 140 starts impact cost calculation for VM_X.

### <S102 and S103>

In S102, the degree-of-impact determination unit 140 confirms the login state of VM_X acquired by the login state confirmation unit 110.

When no user has logged in (No in S103), VM_X is not used, and thus, a determination is made that there is no impact of VM migration, and the impact cost is set to 0.

When any user has logged in (Yes in S103), impact on the user can be caused due to the migration of VM_X, and thus, 50 is added to the impact cost. In a case in which a plurality of users can log in to VM_X, the impact cost to be added becomes high when the number of log-in users is larger.

### <S104 and S105>

In S104, the degree-of-impact determination unit 140 confirms a process in operation in VM_X on the basis of the process state of VM_X acquired by the process state confirmation unit 120.

The initial process state DB 162 stores a process state of each VM when the VM is not used by a user. The degree-of-impact determination unit 140 refers to the initial process state DB 162, and determines that the user has just logged in and does not increase the impact cost when it is found that only the initial process is operating in VM_X (No in S105). Alternatively, a small cost increase (for example, about 5) may be performed.

When a process other than the initial process is present in the operation process (Yes in S105), 50 is added to the impact cost because a possibility of impact on any user is high. A numerical value of the impact cost described in each example is an example.

### <S106 and S107>

In S106, the degree-of-impact determination unit 140 refers to the dangerous process information DB 164 in which a list of processes that cause a problem due to service down has been described, and confirms whether the process described in this dangerous process information DB 164 is operating in VM_X. A process that causes a problem due to service down is, for example, a process adversely impacting on the user due to the service down.

When the dangerous process is not operating (No in S107), addition to the impact cost is not performed. When the dangerous process is operating (Yes in $107), a determination is made that the impact is further higher, and 50 is added to the impact cost for VM_X.

### <S108>

In S108, the degree-of-impact determination unit 140 estimates change in a response speed due to migration when the user accesses VM_X, from the DB 165 in which a band and distance between the user and each base have been held. A case in which one user connects to VM_X will be described here. When a plurality of users connect to VM_X, an average value of the plurality of users may be used, or a value of the user with the largest amount of change may be used.

For example, in a case in which a response speed of communication in the user connecting to VM_X is doubled when VM_X is migrated from base A to base B, and the response speed is halved when VM_X is migrated from base A to base C, for example, 10 is added for the migration to base B, and 10 is subtracted for the migration to base C.

In the above process, the impact cost is not related to the migration destination for S102 to S107, and the impact costs is related to the migration destination for S108. After S108, calculation of the impact cost for the next VM is performed.

FIG. 7 illustrates an example of an impact cost calculation result for VM(1). In this example, an impact cost of a case of migration within a base is 50, an impact cost of a case of migration to base B is 60, and an impact cost of a case of migration to base C is 55.

The impact cost is passed to the VM migration destination decision apparatus 200, and the VM migration destination decision apparatus 200 can use the impact cost for a VM migration determination, such as performing the planned failover when “impact cost=50 or less”.

### Example 2

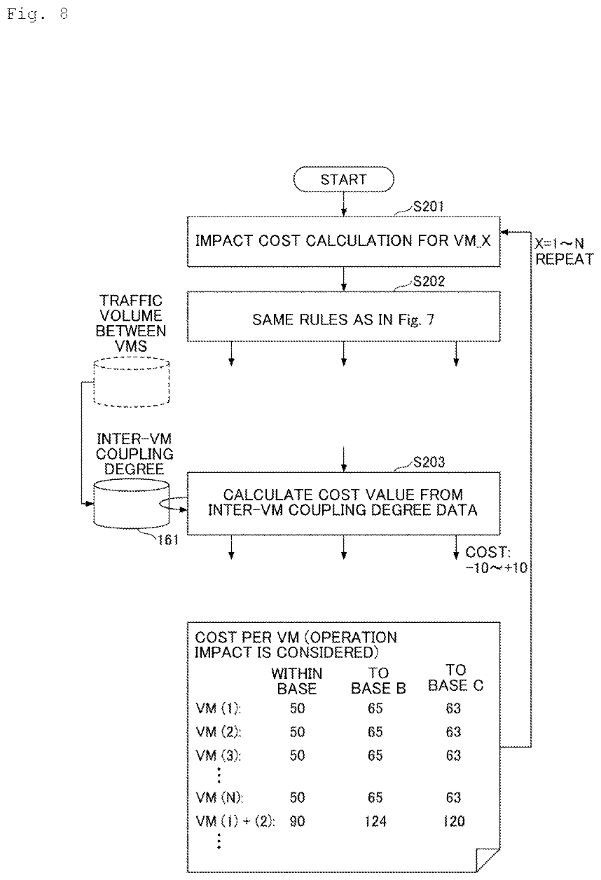

Next, Example 2 will be described. In Example 2, the calculation of the impact cost in which an inter-VM coupling degree has been considered is performed, in addition to the calculation of the impact cost in Example 1. A processing example of Example 2 will be described according to a procedure of a flowchart of FIG. 8.

### <S201>

The degree-of-impact determination unit 140 starts impact cost calculation for a certain VM_X.

### <S202>

In S202, the degree-of-impact determination unit 140 executes processes of S102 to S108 of Example 1 (FIG. 7).

### <S203>

In S203, the degree-of-impact determination unit 140 refers to the inter-VM coupling degree DB 161 to calculate the impact cost on the basis of the inter-VM coupling degree.

When a plurality of VMs cooperate with each other (for example, when a lot of communication is required between the VMs to provide a service to a user), and bases at which the VMs are disposed are different bases, a communication distance between the VMs becomes long and the response quality to the user deteriorates. Thus, a degree of relevance (degree of cooperation) between the VMs is called inter-VM coupling degree. Inter-VMs may be between two VMs or may be among three or more VMs.

In the present embodiment, for example, the administrator stores the inter-VM coupling degree in the inter-VM coupling degree DB 161 in advance for each set of VMs. Alternatively, the VM migration impact cost calculation apparatus 100 may periodically acquire traffic between the VMs, automatically set the inter-VM coupling degree from the traffic amount, and store the inter-VM coupling degree in the inter-VM coupling degree DB 161.

For example, when there is a lot of traffic between VM1 and VM2, the degree of coupling between the VMs is set to be higher than when there is little traffic. Accordingly, the degree-of-impact determination unit 140 calculates the impact cost of the VM migration in which VM1 and VM2 are different bases to be higher than that in a case in which the traffic is small.

For example, the degree-of-impact determination unit 140 acquires the inter-VM coupling degree from the inter-VM coupling degree DB 161 for each set including VM_X, calculates an addition amount of the impact cost for each VM of a combination thereof on the basis of the inter-VM coupling degree, and adds the addition amount to the calculated impact cost of the VM. This addition amount corresponds to an addition amount of the impact cost when the two VMs of the combination are not disposed in the same base.

FIG. 8 illustrates an example of the impact cost in which an inter-VM coupling degree for VM1 and VM2 has been considered. For example, a case in which VM1 and VM2 are migrated to base B is considered. For VM1 and VM2, the impact cost in which it is assumed that VM1 and VM2 are not disposed at the same base is 65 for each of VM1 and VM2, and a sum of the impact costs is 130.

On the other hand, when VM1 and VM2 are migrated together to base B, the impact cost based on the inter-VM coupling degree is subtracted, and thus, the impact cost for two becomes 124, for example, as illustrated in FIG. 8.

As described above, for example, it is possible to perform control so that VMs with a high degree of coupling are always in the same base by considering the VM coupling degree.

### Example 3

Next, Example 3 will be described. In Example 3, impact cost calculation in which operation impact is considered is performed, in addition to the impact cost calculation of Example 1 or Example 2.

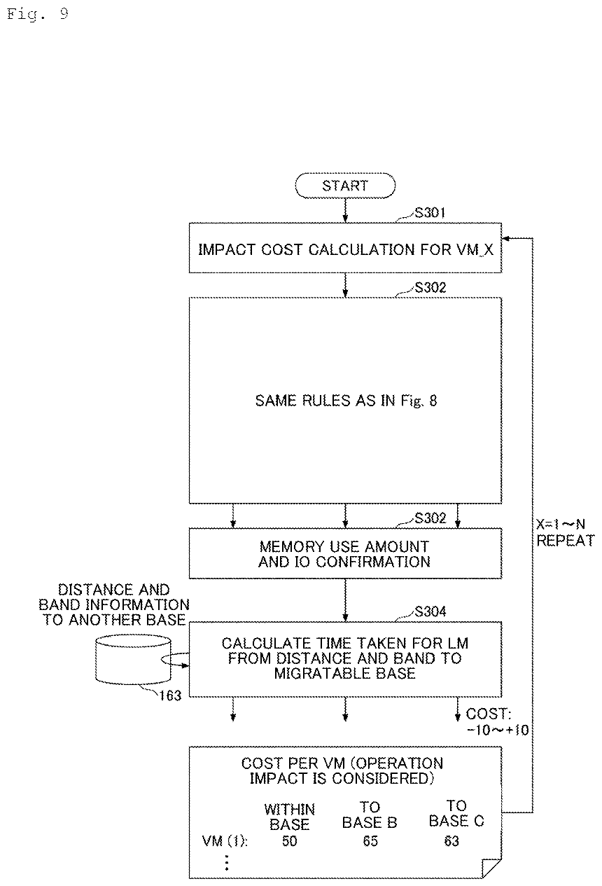

Description will be made according to a procedure of a flowchart in FIG. 9.

### <S301>

The degree-of-impact determination unit 140 starts impact cost calculation for a certain VM_X.

### <S302>

In S302, the degree-of-impact determination unit 140 executes the processes of S102 to S108 of Example 1 (FIG. 7) or the processes of $202 to S203 of Example 2 (FIG. 8).

### <S303>

In S303, the degree-of-impact determination unit 140 confirms a memory use rate and a memory IO of VM_X acquired by the resource state confirmation unit 130.

### <S304>

In S304, the degree-of-impact determination unit 140 acquires a distance and a band between base A and the base that is a migration destination from the DB 163 that stores a distance and a band of each base to another base, calculates a time taken for the live migration from base A to the base that is a migration destination from the distance and band, and the memory use rate of VM_X, and sets the impact cost to be added on the basis of the time. When the distance and the memory use rate are higher, a time taken for the live migration increases. Further, a time required for live migration in the case of a large band is shorter than the case of a small band.

It is possible to flexibly change a cost value to be added, but the cost value is set between −10 and +10, for example.

Further, the degree-of-impact determination unit 140 calculates the impact cost on the basis of a time taken for migration to another server within the same base. This makes it possible to perform control for aggregating VMs on one server, leaving another server empty, and powering off the server.

In any one of Example 1 to Example 3, the impact cost may be added or subtracted on the basis of a resource state of the server at each base acquired by the resource state confirmation unit 130. For example, a threshold value of a resource amount for adding or subtracting the impact cost is stored in the resource-based impact determination definition threshold value DB 166, and the impact cost is added or subtracted by using the threshold value.

As an example, when the CPU use rate of the server at the base that is a migration destination exceeds a threshold value X (for example, 70%), 10 is added to the impact cost for the migration to the base, and when the CPU use rate is equal to or smaller than a threshold value Y (for example, 20%), 10 is subtracted from the impact cost for the migration to the base. Such cost setting enables control for equalizing resource use between bases.

### Example of Use of Impact Cost

Here, an example in a case in which migration control is performed using the impact cost calculated by the VM migration impact cost calculation apparatus 100 will be described. This control is performed by the VM migration destination decision apparatus 200, for example.

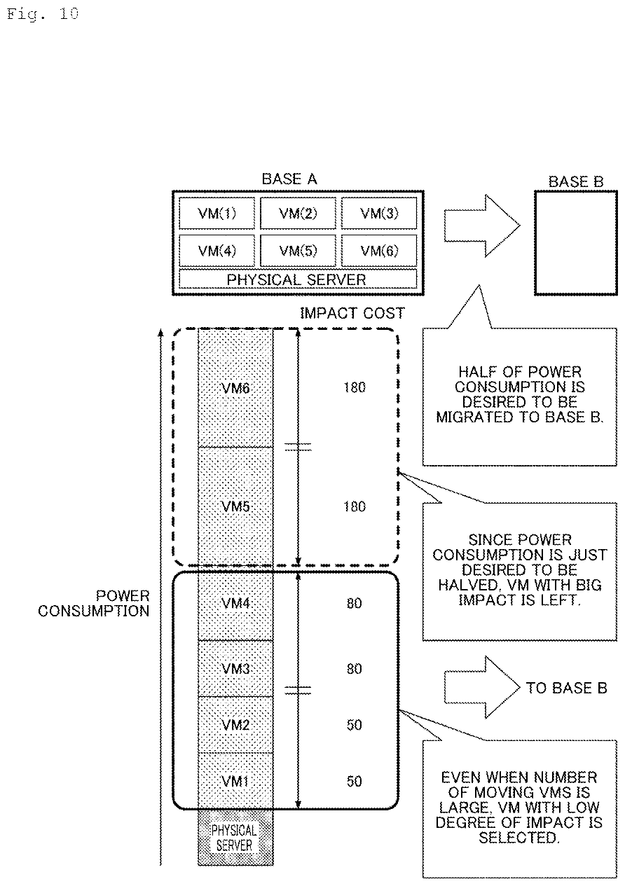

Description will be made with reference to FIG. 10. As illustrated in FIG. 10, it is assumed that VM1 to VM6 are present in base A, and the impact cost in a case in which each VM is migrated to base B is calculated as illustrated in FIG. 10 by the VM migration impact cost calculation apparatus 100. Further, power consumption of each VM is as illustrated in the figure, and it is assumed that VM1 has the lowest power consumption and VM6 has the highest power consumption.

Here, it is assumed that the VM migration destination decision apparatus 200 has decided to move half of the power consumption of the VMs at base A to base B from the viewpoint of power consumption. In this case, the power consumption is halved in “VM1 to VM4” and “VM5 and VM6”, but a sum of impact costs of VM1 to VM4 is 230 and a sum of impact costs of VM5 and VM6 is 360, and thus, the VM migration destination decision apparatus 200 decides that “VM1 to VM4” with a lower degree of impact due to the migration are migrated. Further, a cost of operation impact is individually considered, so that the migration may be performed with live migration in a case in which the cost of the operation impact is low, and the migration may be performed with the planned failover in a case in which the cost of the operation impact is high.

Accordingly, for example, it is possible to perform VM migration while maintaining a balance between “efficient use of renewable energy” and “maintenance of service level.”

### Hardware Configuration Example

Both the VM migration impact cost calculation apparatus 100 and the VM migration destination decision apparatus 200 can be realized by causing a computer to execute a program, for example. This computer may be a physical computer or may be a virtual machine on a cloud. The VM migration impact cost calculation apparatus 100 and the VM migration destination decision apparatus 200 are collectively referred to as an apparatus.

That is, the apparatus can be realized by executing a program corresponding to the processing performed by the apparatus using hardware resources such as a CPU and memory built into the computer. The program can be recorded on a computer-readable recording medium (a portable memory or the like), stored, and distributed. It is also possible to provide the program through a network such as the Internet or e-mail.

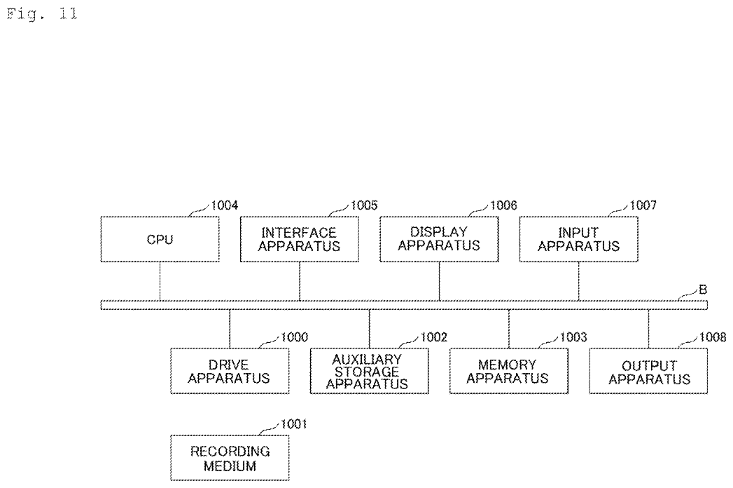

FIG. 11 is a diagram illustrating a hardware configuration example of the computer. The computer of FIG. 11 includes a drive apparatus 1000, an auxiliary storage apparatus 1002, a memory apparatus 1003, a CPU 1004, an interface apparatus 1005, a display apparatus 1006, an input apparatus 1007, an output apparatus 1008, and the like, which are connected to each other by a bus B.

A program for realizing processing in the computer is provided by, for example, a recording medium 1001 such as a CD-ROM or a memory card. When the recording medium 1001 having the program stored therein is set in the drive apparatus 1000, the program is installed in the auxiliary storage apparatus 1002 from the recording medium 1001 via the drive apparatus 1000. However, the program does not necessarily have to be installed from the recording medium 1001, and may be downloaded from another computer via a network. The auxiliary storage apparatus 1002 stores the installed program and also stores necessary files, data, and the like.

The memory apparatus 1003 reads and stores the program from the auxiliary storage apparatus 1002 when there is an instruction to start the program. The CPU 1004 realizes functions related to the apparatus according to the program stored in the memory apparatus 1003. The interface apparatus 1005 is used as an interface for connection to a network. The display apparatus 1006 displays a graphical user interface (GUI) or the like according to a program. The input apparatus 1007 is configured of a keyboard, a mouse, buttons, a touch panel, or the like, and is used to input various operation instructions. The output apparatus 1008 outputs a calculation result.

### Effects of Embodiment

The technology according to the embodiment makes it possible to ascertain the degree of impact in a case in which the VM is migrated. Therefore, for example, when a large number of VMs should be migrated to a remote base all at once, it is possible to decide the VMs that are migration target or a migration scheme thereof (which VM should be migrated by using which scheme) so that the degree of impact is minimized.

### (Supplements)

The present specification discloses at least the following impact cost calculation apparatus, impact cost calculation method, and program.

(1)

An impact cost calculation apparatus for calculating an impact cost in a case in which a virtual machine is migrated within a base or between the bases at a plurality of bases including the virtual machines, the impact cost calculation apparatus including: a state confirmation unit configured to acquire either a login state or a process state, or both the login state and the process state, in each virtual machine provided at the base; and
a degree-of-impact determination unit configured to calculate, for each virtual machine, an impact cost for a user caused by migration of the virtual machine, on the basis of either the login state or the process state or both the login state and the process state.
   (2)

The impact cost calculation apparatus according to (1), wherein the degree-of-impact determination unit increases the impact cost when a process other than an initial process is present in an operation process of the virtual machine, or increases the impact cost when a service is down and a process impacting on the user is operating.

(3)

The impact cost calculation apparatus according to (1) or (2), wherein the degree-of-impact determination unit calculates, for each virtual machine, an impact cost of each base serving as a migration destination, on the basis of a distance and a band between the user and each base.

(4)

The impact cost calculation apparatus according to any one of (1) to (3), wherein the degree-of-impact determination unit calculates an impact cost of a plurality of cooperating virtual machines, on the basis of an inter-virtual machine coupling degree for the plurality of virtual machines.

(5)

The impact cost calculation apparatus according to any one of (1) to (4), wherein the degree-of-impact determination unit calculates, for each virtual machine, an impact cost of each base on the basis of a time taken for migration the virtual machine between servers within the base and a time taken for migration of the virtual machine between the bases.

(6)

An impact cost calculation method executed by an impact cost calculation apparatus for calculating an impact cost in a case in which a virtual machine is migrated within a base or between the bases at a plurality of bases including the virtual machines, the impact cost calculation method including: a state confirmation step of acquiring either a login state or a process state, or both the login state and the process state, in each virtual machine provided at the base; and
a degree-of-impact determination step of calculating, for each virtual machine, an impact cost for a user caused by migration of the virtual machine, on the basis of either the login state or the process state or both the login state and the process state.
   (7)

A program for causing a computer to function as each unit in the impact cost calculation apparatus according to any one of (1) to (5).

Although the embodiment has been described above, the present invention is not limited to such a specific embodiment, and various modifications and changes can be made within the scope of the gist of the present invention described in the claims.

### REFERENCE SIGNS LIST

100 VM migration impact cost calculation apparatus
110 Login state confirmation unit
120 Process state confirmation unit
130 Resource state confirmation unit
140 Degree-of-impact determination unit
150 Degree-of-impact output unit
161 Inter-VM coupling degree DB
162 Initial process state DB
163 Distance-to-another-base and band DB
164 Dangerous Process DB
165 DB for distance and band between user and base
166 Resource-based impact determination definition
threshold value DB
200 VM migration destination decision apparatus
300 Network
1000 Drive apparatus
1001 Recording medium
1002 Auxiliary storage apparatus
1003 Memory apparatus
1004 CPU
1005 Interface apparatus
1006 Display apparatus
1007 Input apparatus
1008 Output apparatus

1. An impact cost calculation apparatus for calculating an impact cost in a case in which a virtual machine is migrated within a base or between the bases at a plurality of bases including the virtual machines, the impact cost calculation apparatus comprising:
a processor; and
a memory storing program instructions that cause the processor to:
acquire either a login state or a process state, or both the login state and the process state, in each virtual machine provided at the base; and
calculate, for each virtual machine, an impact cost for a user caused by migration of the virtual machine, on the basis of either the login state or the process state or both the login state and the process state.

2. The impact cost calculation apparatus according to claim 1, wherein the program instructions cause the processor to increase the impact cost when a process other than an initial process is present in an operation process of the virtual machine, or increase the impact cost when a service is down and a process impacting on the user is operating.

3. The impact cost calculation apparatus according to claim 1, wherein the program instructions cause the processor to calculate, for each virtual machine, an impact cost of each base serving as a migration destination, on the basis of a distance and a band between the user and each base.

4. The impact cost calculation apparatus according to claim 1, wherein the program instructions cause the processor to calculate an impact cost of a plurality of cooperating virtual machines, on the basis of an inter-virtual machine coupling degree for the plurality of virtual machines.

5. The impact cost calculation apparatus according to claim 1, wherein the program instructions cause the processor to calculate, for each virtual machine, an impact cost of each base on the basis of a time taken for migration of the virtual machine between servers within the base and a time taken for migration of the virtual machine between the bases.

6. An impact cost calculation method executed by an impact cost calculation apparatus for calculating an impact cost in a case in which a virtual machine is migrated within a base or between the bases at a plurality of bases including the virtual machines, the impact cost calculation method comprising:
acquiring either a login state or a process state, or both the login state and the process state, in each virtual machine provided at the base; and
calculating, for each virtual machine, an impact cost for a user caused by migration of the virtual machine, on the basis of either the login state or the process state or both the login state and the process state.

7. A non-transitory computer-readable recording medium having stored therein a program for causing a computer to perform the impact cost calculation method according to claim 6.
